(19) United States
(12) Patent Application Publication
(10) Pub. No.: US 2014/0236719 A1
(43) Pub. Date: Aug. 21, 2014

(54) SYSTEMS AND METHODS FOR PROVIDING AN ONLINE MARKETPLACE FOR ROUTE GUIDANCE

(71) Applicants: DALILA SZOSTAK, Portland, OR (US); ALEXANDRA C. ZAFIROGLU, Portland, OR (US); JENNIFER A. HEALEY, San Jose, CA (US)

(72) Inventors: DALILA SZOSTAK, Portland, OR (US); ALEXANDRA C. ZAFIROGLU, Portland, OR (US); JENNIFER A. HEALEY, San Jose, CA (US)

(21) Appl. No.: 13/768,696

(22) Filed: Feb. 15, 2013

(51) Int. Cl. G06Q 30/06; G01C 21/00

(52) U.S. Cl. CPC G06Q 30/0625; G01C 21/00
USPC 705/14.54; 701/537; 701/533; 705/26.62

(57) ABSTRACT

Customized route guidance presentations associated with various routes may be generated based on data reflective of anecdotal knowledge and preferences associated with travelers. A marketplace may be provided for searching and purchasing the route guidance presentations. Providers of the data may be compensated upon purchase of the route guidance presentations.

### TECHNICAL FIELD

The present disclosure relates generally to interactive marketplaces, and more particularly, to an online marketplace for route guidance.

### BACKGROUND

A digital marketplace may provide users with a forum for exchanging, selling and purchasing digital content. The content may include a variety of types of content including audio content, video content, textual content, graphical content, multimedia content, and so forth.

### BRIEF DESCRIPTION OF THE FIGURES

The detailed description is set forth with reference to the accompanying drawings. In the drawings, the left-most digit(s) of a reference numeral identifies the drawing in which the reference numeral first appears. The use of the same reference numerals indicates similar or identical components; however, different reference numerals may be used to identify similar or identical components as well. Various embodiments may utilize element(s) and/or component(s) other than those illustrated in the drawings and some element(s) and/or component(s) may not be present in various embodiments. The use of singular terminology to describe a component or element may, depending on the context, encompass a plural number of such components or elements and vice versa.

FIG. 1 is a schematic block diagram of an illustrative system architecture for providing and interacting with an online marketplace for route guidance presentations in accordance with one or more embodiments of the disclosure.

FIG. 2 is a schematic block diagram of an illustrative seller device configured to capture data that may be utilized to generate route guidance presentations in accordance with one or more embodiments of the disclosure.

FIG. 3 is a schematic block diagram of an illustrative server system for generating and distributing route guidance presentations in accordance with one or more embodiments of the disclosure.

FIG. 4 is a schematic diagram of illustrative types of data associated with a route guidance presentation in accordance with one or more embodiments of the disclosure.

FIG. 5 is a process flow diagram of an illustrative method for generating route guidance presentations and making the route guidance presentations available via a digital marketplace in accordance with one or more embodiments of the disclosure.

FIG. 6 is a process flow diagram of an illustrative method for generating route guidance presentations based at least in part on route data and associated interactive data in accordance with one or more embodiments of the disclosure.

FIG. 7 is a process flow diagram of an illustrative method for submitting a query for route guidance presentations in accordance with one or more embodiments of the disclosure.

FIG. 8 is a process flow diagram of an illustrative method for generating various types of contextual data in accordance with one or more embodiments of the disclosure.

FIG. 9 is an illustrative user interface associated with a digital marketplace for route guidance presentations in accordance with one or more embodiments of the disclosure.

### DETAILED DESCRIPTION

Route guidance systems have now become a primary navigation tool for many travelers. Conventional route guidance systems rely on a variety of types of heuristics to identify a route between an origin location and a destination location. Examples of such heuristics may include a minimum distance, a fastest travel time, maximum use of a particular type roadway (e.g., highways), and so forth. Conventional route guidance systems may utilize map data and/or historical traffic data to identify a route that satisfies a particular heuristic or a particular set of heuristics.

However, a disadvantage associated with conventional route guidance systems is that they fail to effectively utilize anecdotal knowledge and experience to personalize or customize routes for particular users. For example, an individual who routinely travels within a particular area may be acutely aware of locations that are prone to traffic congestion, of shortcuts or alternate routes that reduce travel time but may not be readily calculable, and so forth. As another example, certain individuals may prefer to take certain routes even though such routes may not satisfy certain heuristics. For example, a person may prefer to take a scenic route to work even though the route does not satisfy shortest distance or fastest travel time heuristics. Conventional route guidance systems are not able to modify or customize routes to account for user preferences and, as a result, users may be left with unsatisfactory experiences.

Individuals that routinely travel in particular areas may possess unique knowledge about various aspects relating to travel within those areas such as knowledge pertaining to less congested routes, more scenic routes, routes that include potentially desirable landmarks, routes that are appropriate for particular types of vehicles, timing characteristics associated with traffic congestion, and so forth. These “local experts” may have a variety of knowledge, experience, and preferences that may be utilized to inform the travel decisions of other travelers and thereby improve their travel experience.

As a non-limiting example, a local expert may commute from home to work each day using a motorcycle as her typical mode of transportation. As a result of its smaller size as compared to an automobile for example, an individual travelling on a motorcycle may be able to make use of more surface roads or roads with narrower pathways. As such, the motorcycle traveler described above may have a particular route for her commute that is customized for transportation via motorcycle. The route identified based on knowledge specific to the motorcycle traveler may be more desirable to another traveler seeking to traverse a similar or the same route via motorcycle than a route determined solely based on algorithmically calculated heuristics.

Embodiments of this disclosure relate to, among other things, systems, methods, computer-readable media, techniques and methodologies for generating route guidance presentations based on route data and providing a marketplace via which the route guidance presentations may be searched and purchased. The route data may be indicative of characteristics associated with one or more routes, preferences associated with one or more travelers associated with the routes, and so forth. A service provider system may be provided that receives the route data, and as will be described in more detail hereinafter, potentially various other forms of data associated with the route data. The route data may be gathered, collected and/or generated by a route data collection module that may be executed on one or more computing devices associated with one or more travelers. The route data that is collected may include location coordinates corresponding to locations that have been traversed, corresponding time stamps, preferences associated with the one or more travelers, identifying information associated with the traveler(s) or their associated devices, and so forth. In certain embodiments, the traveler(s) may be provided with various incentives—monetary or otherwise—to incentivize the traveler(s) to provide the route data.

In certain embodiments of the disclosure, interactive data may be received in association with the route data. The interactive data may include any of a variety of types of content such as audio content, video content, graphical content, textual content, and so forth. The service provider system may be configured to identify one or more triggering conditions based at least in part on the interactive data and the route data. The triggering conditions may correspond to particular locations along a route or other parameters associated with a route that may, in turn, be associated with particulars portions of the interactive data. A route guidance presentation may be generated based at least in part on the triggering condition(s) such that when a user traversing a route in accordance with the route guidance presentation arrives at a particular location along the route, a triggering condition associated with that location is satisfied and interactive data associated with that location is rendered for presentation to the user.

In still further embodiments of the disclosure, once generated, the service provider system may be configured to distribute the route guidance presentations to users via one or more digital marketplaces. Contextual information associated with the route guidance presentations may also be generated and provided in association with the route guidance presentations. In certain embodiments, the service provider system may receive from a user device on behalf of a prospective purchaser, a query for one or more route guidance presentations, wherein the query identifies one or more locations and one or more preferences associated with the prospective purchaser. The service provider system may identify and transmit to the user device an indication of one or more candidate route guidance presentations identified based at least in part on the location and the one or more preferences associated with the prospective purchaser. In certain embodiments, the one or more locations may include a current location associated with the user device. The service provider system may receive, from the user device on behalf of the prospective purchaser, an indication of a selected route guidance presentation of the one or more candidate route guidance presentations and may facilitate execution of a purchase transaction associated with the selected route guidance presentation.

More specifically, upon receiving from the user device on behalf of the prospective purchaser, an indication of a selection of a route guidance presentation, a purchase price for the selected route guidance presentation may be determined and a purchase transaction may be executed. Further, an applied incentive may be transmitted to a seller (e.g., a traveler that provided the route data based on which the route guidance presentation was generated) based at least in part on the purchase price. The applied incentive may be a monetary incentive, an incentive in-kind, or the like.

As a non-limiting example, certain areas may be heavily congested at particular times while relatively congestion-free at other times. For example, a science fiction parade is held in the city of Atlanta, Ga. on the first Saturday of September each year. As a result of the parade, a main thoroughfare—Peachtree Street—is blocked south of Eighth Street. If a tourist (or someone generally unfamiliar with the Atlanta area) were to come to Atlanta that week and attempt to navigate using a traditional route guidance system, the route guidance system may not be configured to account for the non-typical traffic conditions associated with this event. As such, a conventional navigation system may direct the tourist to a closed street. However, a local who resides in Atlanta may be aware of the fact that some streets are closed during the parade and may provide route data indicative of these atypical circumstances. A route guidance presentation may be generated based on this route data and the route guidance presentation may be utilized by a tourist to more effectively navigate the streets of Atlanta during the parade.

These and other embodiments of the disclosure will be described in greater detail hereinafter through reference to the accompanying drawings.

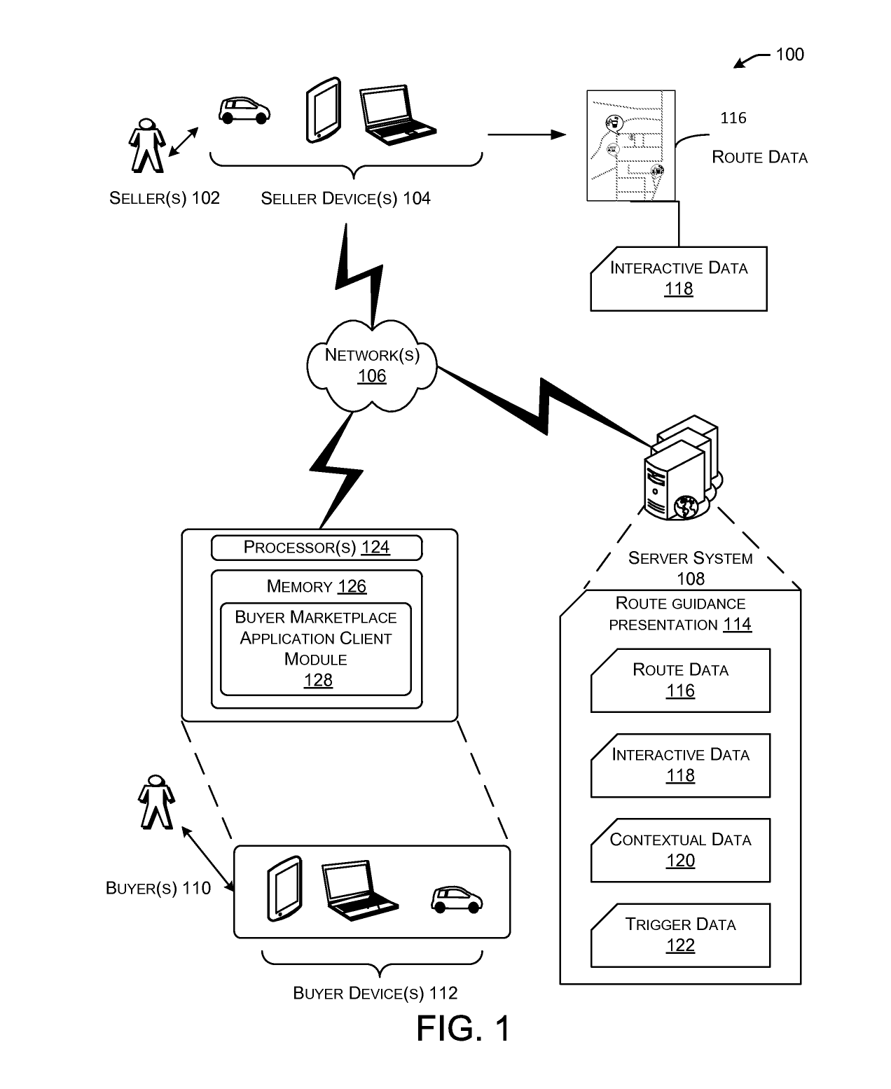

FIG. 1 is a schematic block diagram of an illustrative system architecture 100 for generating route guidance presentations and providing the presentations via an online marketplace in accordance with one or more embodiments of the disclosure.

The illustrative system architecture 100 may include a server system 108 that may be configured to facilitate interaction between sellers and buyers of route guidance presentations via an online marketplace. The server system 108 may include any number of processor-driven devices including, but not limited to, a server computer, a personal computer, one or more networked computing devices, an application-specific integrated circuit, a minicomputer, a microcontroller, and/or any other processor-based device and/or any combination of such devices.

The server system 108 may be communicatively coupled to one or more networks 106. The networks 106 may include any one or a combination of different types of suitable communications networks, such as cable networks, the Internet, wireless networks, cellular networks, and other private and/or public networks. Furthermore, the network(s) 106 may include any variety of medium over which network traffic is carried including, but not limited to, coaxial cable, twisted wire pair, optical fiber, hybrid fiber coaxial (HFC), microwave terrestrial transceivers, radio frequency communications, satellite communications, or combinations thereof.

The server system 108 may be configured to receive route data 116 and other associated types of data from one or more sellers 102. The one or more sellers 102 may be associated with one or more seller devices 104. The seller device(s) 104 may include, but are not limited to, a personal computer, a desktop computer, a notebook computer, a laptop computer, a personal digital assistant (PDA), an electronic book reader (e-book reader), a tablet computing system, a vehicle computing system, a global positioning system (GPS), a smartphone, a portable gaming device, or any other suitable device or combinations thereof. The seller device 104 may include one or more user interfaces for receiving input from a user. The seller device 104 may include network interface(s) for communicating with various other components of the system architecture 100 (e.g., the server system 108) via the network(s) 106 in accordance with any suitable communication standard including, but not limited to, Wi-Fi, Wi-Fi Direct, Bluetooth®, Bluetooth® low energy (BLE), various cellular communication standards such as Third Generation (3G), Fourth Generation (4G), Long-term Evolution (LTE), Worldwide Interoperability for Microwave Access (WiMAX), and so forth.

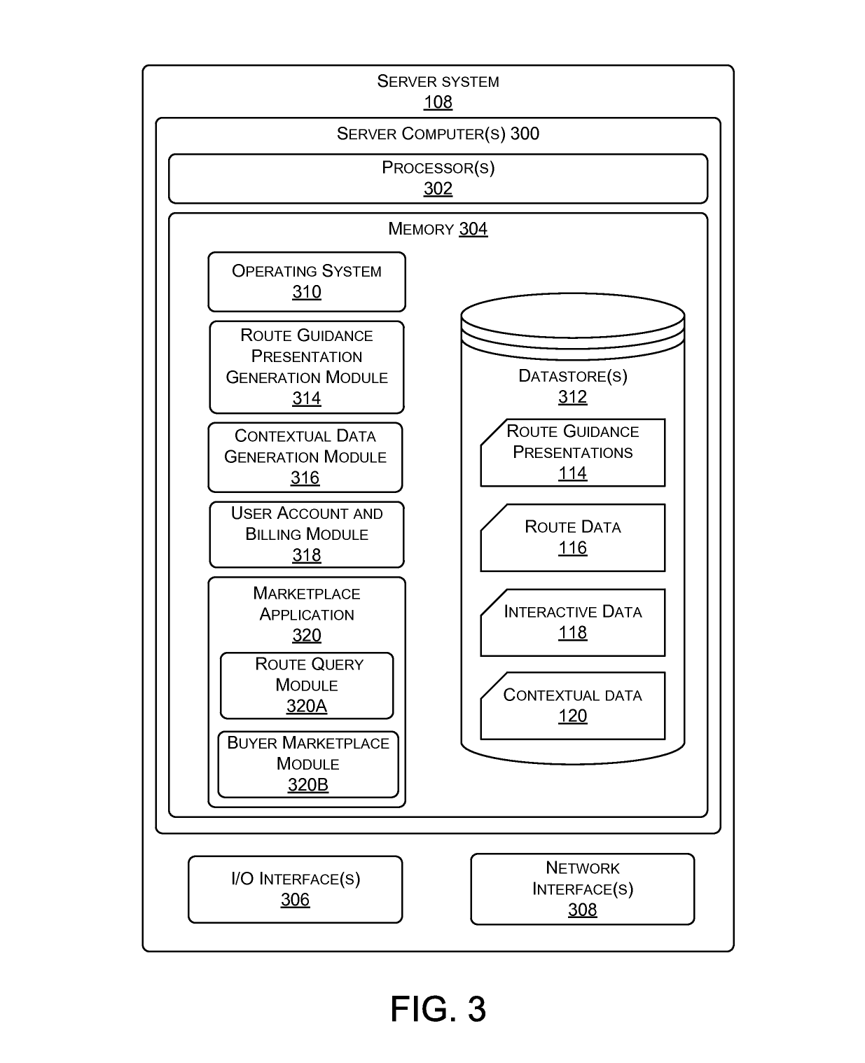

The seller device 104 may be configured to collect, gather or otherwise obtain various route data 116. Interactive data 118 may also be generated and associated with the route data 116. The seller device 104 may be configured to transmit the route data 116 and the associated interactive data 118 to the server system 108 via the network(s) 106. Illustrative seller devices 104 and associated functionality supported by the seller devices 104 will be discussed in greater detail below through reference to FIGS. 3-8.

The system architecture 100 may further include one or more buyer devices 112 associated with one or more buyers 110. The buyer device(s) 112 may include, but are not limited to, a personal computer, a desktop computer, a notebook computer, a laptop computer, a personal digital assistant (PDA), an electronic book reader (e-book reader), a tablet computing system, a vehicle computing system, a global positioning system (GPS), a smartphone, a portable gaming device, or any other suitable device or combinations thereof.

The buyer device(s) 112 may be include one or more processors (processor(s)) 124 and at least one memory 126 (generically referred to herein as memory 126). The processor(s) 124 may comprise one or more processing cores and may be configured to access and execute computer-executable instructions stored in the memory 126 in order to cause various operations to be performed. The memory 126 may include, but is not limited to, random access memory (RAM), flash RAM, magnetic media storage, optical media storage, and so forth. The memory 126 may be volatile memory configured to store information when supplied with power and/or non-volatile memory configured to store information even when not supplied with power.

As previously noted, the memory 126 may include computer-executable instructions stored thereon that upon execution by the processor(s) 124 cause various operations to be performed. The memory 126 may have an operating system stored thereon for managing hardware resources and providing services to applications or modules executing on the buyer device 112. The memory 126 may further store a variety of data manipulated and/or generated during execution of computer-executable instructions by the processor(s) 124.

The memory 126 may further include a buyer marketplace application client module 128. The buyer marketplace application client module 128 may be configured to render a user interface on the buyer device 112 via which the buyer 110 may interact with a marketplace application that may be hosted by the server system 108. In certain embodiments, the buyer marketplace application client module 128 may represent a client-side portion of a marketplace application hosted by the server system 108.

The buyer device(s) 112 may further include various hardware, software and/or firmware components not depicted in FIG. 1. For example, the buyer device(s) 112 may include one or more input/output (I/O) interfaces that may support a variety of I/O devices such as a display, a camera, a keyboard, or the like for receiving input from and providing output to a user, one or more network interfaces, a global positioning system, and so forth. The buyer device(s) 112 may further include one or more network interfaces that may facilitate communication with various other components of the system architecture 100 (e.g., the server system 108) via the network(s) 106 in accordance with any suitable communication standard including, but not limited to, Wi-Fi, Wi-Fi Direct, Bluetooth®, Bluetooth® low energy (BLE), various cellular communication standard such as Third Generation (3G), Fourth Generation (4G), Long-term Evolution (LTE), Worldwide Interoperability for Microwave Access (WiMAX), and so forth.

Referring again to the route data 116 received from the seller device(s) 104, the route data 116 may include information associated with previously traversed routes such as location coordinates corresponding to locations that have been traversed, corresponding time stamps such as arrival and departure times, preferences associated with one or more travelers, identifying information associated with the traveler(s) or their associated devices, and so forth. The route data 116 may also include information that identifies a mode of transportation associated with a route. Interactive data 118 may be provided in association with the route data 116 and may include, but is not limited to, navigation content, audio content, video content, graphical content, textual content, animated content, and so forth.

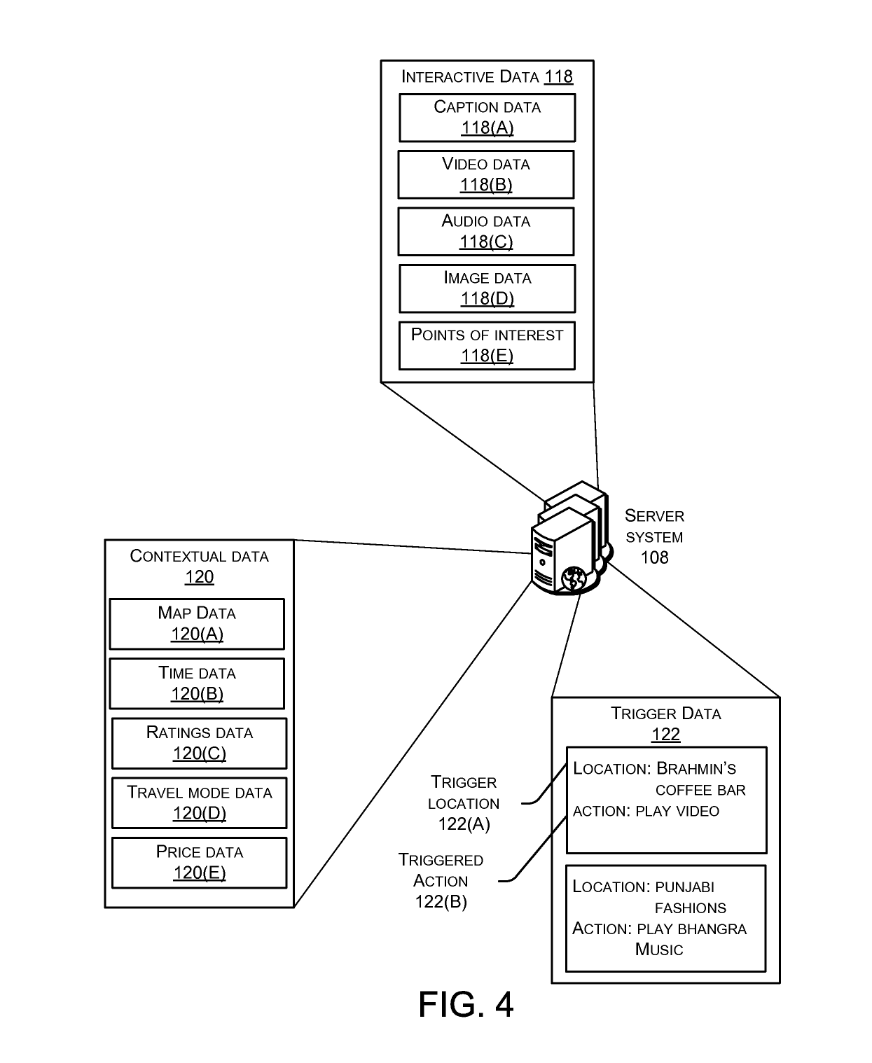

The server system 108 may generate one or more route guidance presentations 114 based at least in part on the route data 116 and the interactive data 118. For the sake of simplicity, the route guidance presentation(s) 114 will be described in the singular; however, it should be appreciated that any number of route guidance presentations 114 may be generated based on the received route data 116 and interactive data 118. The server system 108 may be further configured to generate contextual data 120 associated with the route guidance presentation 114. The contextual data 120 may be generated based at least in part on the route data 116, the interactive data 118, and/or any other type of data (e.g., trigger data 122). The contextual data 120 may provide information about the route guidance presentations 114 such as contextual keywords indicative of characteristics associated with the routes. The contextual data 120 will be discussed in more detail through reference to FIG. 4.

The route guidance presentations 114 may be sold or traded via a digital marketplace. The server system 108 may be configured to host a marketplace application by which the server system 108 may manage, transmit, and sell route guidance presentations 114. As previously described, the buyer marketplace application client module 128 provided on the buyer device 112 may be configured to access a server-side portion of the marketplace application accessible via an associated user interface capable of being rendered on the buyer device 112.

The server system 108 may be further configured to generate trigger data 122 based at least in part on the route data 116 and/or the interactive data 118 that may specify triggering conditions that when satisfied cause various associated portions of the interactive data 118 to be presented to a user. For example, the trigger data 122 may specify trigger conditions associated with particular events, locations, or other parameters associated with a route that when satisfied cause associated interactive data to be presented to a user. The trigger data 122 will be described in more detail through reference to FIG. 4.

Various embodiments of the disclosure may be implemented at least partially in software and/or firmware. The software and/or firmware may take the form of instructions stored in or on a non-transitory computer-readable storage medium. Those instructions may then be read and executed by one or more processors to enable performance of the operations described herein. The instructions may be in any suitable form, such as but not limited to, source code, compiled code, interpreted code, executable code, static code, dynamic code, or the like. As used herein, a non-transitory computer-readable medium may include any tangible non-transitory medium for storing information in a machine-readable form, such as but not limited to, read only memory (ROM); random access memory (RAM); magnetic disk storage media; optical storage media; flash memory, or the like.

One or more components of the systems and/or one or more elements of the methods described herein may include and/or be implemented through one or more application programs executing on any suitable computing device including, but not limited to, handheld devices, multiprocessor systems, microprocessor-based or programmable consumer electronics, mini-computers, mainframe computers, and so forth.

Such application programs may include routines, programs, components, data structures, or the like configured to implement certain abstract data types and perform certain tasks or actions. In a distributed computing environment, the application program (in whole or in part) may be stored in local memory or in other storage such as internal or external data storage. In addition, or in the alternative, the application program (in whole or in part) may be located in remote memory or in other remote storage such as in scenarios where tasks are performed by remote processing devices via one or more communication networks.

The illustrative system architecture depicted in FIG. 1 is provided by way of example only. Numerous other operating environments, system architectures, and device configurations are possible. Accordingly, embodiments of the disclosure should not be construed as being limited to any particular operating environment, system architecture, or device configuration.

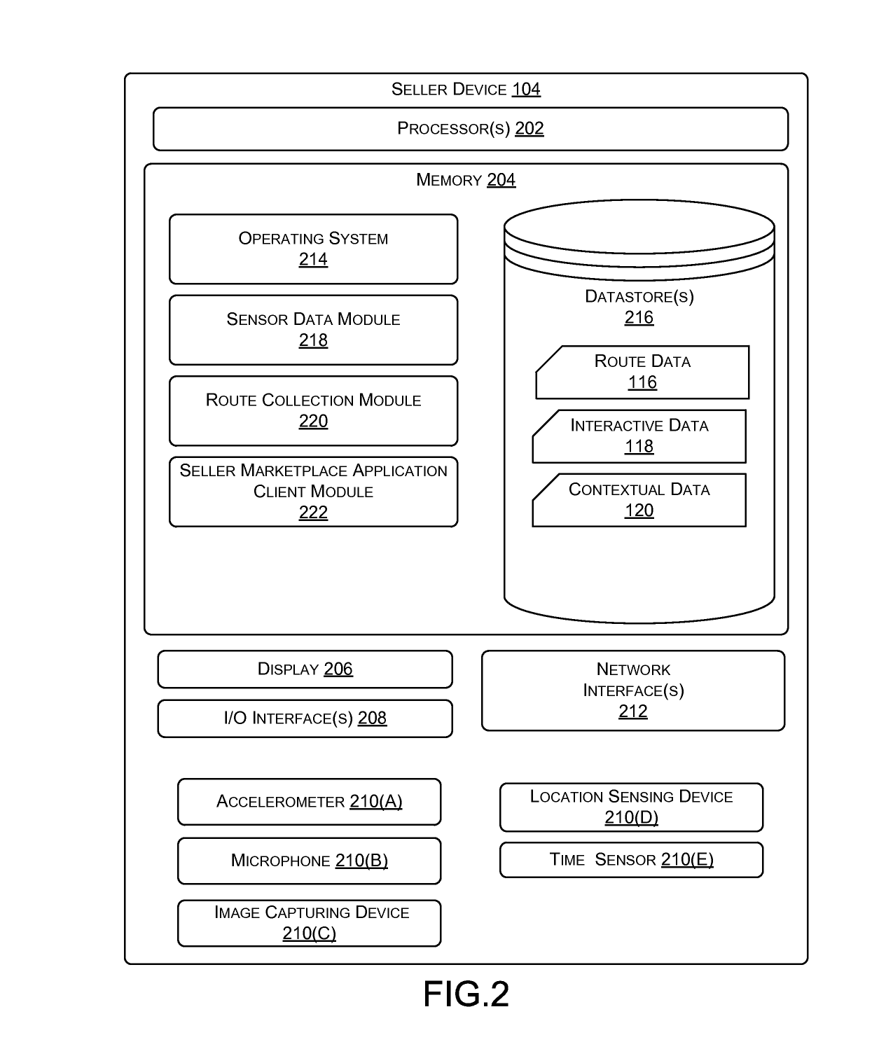

FIG. 2 is a schematic block diagram of an illustrative seller device 104 configured to gather and/or generate data that may be used to generate route guidance presentations in accordance with one or more embodiments of the disclosure. In certain embodiments, the seller device 104 may be implemented or embodied as a component of another system or device, such as a vehicle computing system (VCS) associated with a vehicle. The seller device 104 may include any processor-driven device including, but not limited to, any of the devices previously discussed.

The seller device 104 may include one or more processors (processor(s)) 202 configured to access and execute computer-executable instructions stored in at least one memory 204 (generically referred to herein as memory 204). The processor(s) 202 may be implemented as appropriate in hardware, software, firmware, or combinations thereof. Software or firmware implementations of the processor(s) 202 may include computer-executable or machine-executable instructions written in any suitable programming language to perform the various functions described herein. The processor(s) 202 may include, without limitation, a central processing unit (CPU), a digital signal processor (DSP), a reduced instruction set computer (RISC) processor, a complex instruction set computer (CISC) processor, a microprocessor, a microcontroller, a field programmable gate array (FPGA), a System-on-a-Chip (SOC), or any combination thereof. The seller device 104 may also include a chipset (not shown) for controlling communications between the processor(s) 202 and one or more of the other components of the seller device 104. In certain embodiments, the seller device 104 may be based on an Intel® Architecture system, and the processor(s) 202 and chipset may be from a family of Intel® processors and chipsets, such as the Intel® Atom® processor family. The processor(s) 202 may also include one or more application-specific integrated circuits (ASICs) or application-specific standard products (ASSPs) for handling specific data processing functions or tasks.

The memory 204 may include, but is not limited to, random access memory (RAM), flash RAM, magnetic media storage, optical media storage, and so forth. The memory 204 may include volatile memory configured to store information when supplied with power and/or non-volatile memory configured to store information even when not supplied with power. As will be described in more detail later in this disclosure, the memory 204 may store various program modules, application programs, and so forth that may include computer-executable instructions that upon execution by the processor(s) 202 may cause various operations to be performed. The memory 204 may further store a variety of data manipulated and/or generated during execution of computer-executable instructions by the processor(s) 202.

The seller device 104 may further include one or more I/O interfaces 208 that may facilitate interaction between a user and the seller device 104 using one or more I/O devices. The I/O device(s) may include, but are not limited to, a remote control, a display, a keypad, a mouse, a pointing device, a control panel, a touch screen display, a microphone, a speaker, and so forth. More specifically, the I/O interface(s) 208 may include hardware, firmware, and/or software for receiving input from a user and providing output to a user via one or more I/O devices. The I/O interfaces 208 may also be configured to receive input provided to peripheral devices or external sensor devices such as a global positioning system (GPS) receiver, a vehicle computing system (VCS), or the like.

As previously described, the I/O interfaces 208 may support one or more display devices (generically referred to herein as display 206) configured to render and output information to a user. The display 206 may comprise a reflective or emissive display configured to present images to the user. In some implementations, the display 206 of the seller device 104 may use emissive, reflective, or combination displays with emissive and reflective elements.

The seller device 104 may further include one or more network interfaces 212 that may facilitate communication between the seller device 104 and one or more other systems or system components via the network(s) 106 using any suitable communications standard including any of those previously described.

The seller device 104 may additionally include one or more sensors 210(A)-210(E) (generically referred to herein as sensors 210) that capture data associated with one or more sensed parameters. The sensors 210 may include, but are not limited to, an accelerometer 210(A), a microphone 210(B), a still or moving image capturing device 210(C), a location sensing device 210(D), a time sensor 210(E), and so forth. While the sensors 210 are depicted as being provided internally to the seller device 104, in certain embodiments, one or more components of the sensors 210 may be provided externally to the seller device 104. The data captured by the sensors 210 may be used to generate and/or contextualize the route data 116.

The accelerometer 210(A) may be implemented as appropriate in hardware, software, firmware, or combinations thereof. Software or firmware implementations of the accelerometer 210(A) may include computer-executable or machine-executable instructions written in any suitable programming language to perform the various functions described herein. The accelerometer 210(A) may sense and measure acceleration of either the seller device 104 or a vehicle or other device(s) associated with the seller device 104. In certain embodiments, the accelerometer 210(A) may be configured to sense acceleration along multiple axes. The accelerometer 210(A) may be configured to sense changes in acceleration as well.

The microphone 210(B) may be provided either internally to or externally from the seller device 104 and may be configured to receive audio as input and provide audio output. In certain embodiments, input received via the microphone 210(B) may be used to generate at least a portion of the interactive data 116.

The still or moving image capturing device 210(C) may be provided internally to or externally from the seller device 104 and may be configured to capture, for example, images and video associated with various routes. Data captured by the image capturing device 210(C) may be used, at least in part, to generate one or more route guidance presentations 114 and may assist a user with navigation. For example, images and/or video captured by the image capturing device 210(c) may provide a user with a tour or a virtual representation of a route associated with a route guidance presentation 114.

The location sensing device 210(D) may include, but is not limited to, a global positioning system (GPS) receiver, radio receiver, satellite positioning and triangulation module, and so forth. The location sensing device 210(D) may receive data indicative of a position of the seller device 104. In certain embodiments, a GPS receiver may track a current position of the seller device 104 according to any suitable schedule (e.g., at predetermined intervals). The location sensing device 210(D) may output a data file or a log that may identify a respective position of the seller device 104 over time. The output may include latitude and/or longitude coordinates, GPS positioning coordinates, or other coordinates that identify the location of the seller device 104. The position tracking data captured by the location sensing device 210(D) may be provided as at least a portion of the route data 116 to the server system 108. The time sensor 210(E) may be an internal clock capable of determining time, or alternatively, may receive time information via the network(s) 106 from one or more other devices.

The memory 204 may store various program modules, application programs, and so forth that may include computer-executable instructions that upon execution by the processor(s) 202 may cause various operations to be performed. For example, the memory 204 may include an operating system module (O/S) 214 that may be configured to manage hardware resources such as the I/O interfaces 208 and/or the network interface(s) 212 and provide various services to applications executing on the seller device 104. The memory 204 may also include one or more datastores 216 that may store a variety of information such as the route data 116, the interactive data 118, and the contextual data 120. Although not depicted, the datastore(s) 216 may further store the trigger data 122 or any other suitable types of data. The datastore(s) 216 may store information in accordance with any suitable data structure including, but not limited to, lists, arrays, databases, flat files, and so forth. In some implementations, the datastore(s) 216 may be provided externally from but accessible by the seller device 104. In certain implementations, the datastore(s) 216 may be accessible via a network (e.g., one or more of the network(s) 106) using the network interface(s) 212.

The memory 204 may further store additional program modules such as a sensor data module 218, a route collection module 220, and a seller marketplace application client module 222 which may support a variety of functionality (as will be described in greater detail hereinafter) including collecting route data 116 and/or interactive data 118 and providing the collected data to the server system 108 potentially in return for one or more incentives.

The sensor data module 218 may include computer-executable instructions that when executed by the processor(s) 202 configures the processor(s) 202 to receive sensor data from the various sensors 210 and generate the route data 116. The location sensing device 210(D) may, for example, sample the location of a vehicle at predetermined or user-specified intervals in order to identify routes, which may be contextualized with data received from other sensors 210 by the sensor data module 218 in order to generate the route data 116.

The memory 204 may also store the route collection module 220 which may utilize the route data 116 to identify and generate interactive data 118 associated with the route data 116. Data gathered by one or more of the sensors 210 may be utilized to generate the interactive data 118. Further, the route collection module 220 may include computer-executable instructions for facilitating the transmission of the route data 116 and the interactive data 118 from the seller device to the server system 108 via one or more of the network(s) 106.

In various embodiments, a seller marketplace application client module 222 may also loaded into the memory 204 and may include computer-executable instructions that when executed by the processor(s) 202 cause various operations to be performed. For example, the seller marketplace application client module 222 may be configured to render a user interface on the seller device 104 via which a seller 102 associated with the seller device 104 may interact with a marketplace application that may be hosted by the server system 108. The seller 102 may utilize the seller marketplace application client module 222 to upload route data 116 and associated interactive data 118 via the associated user interface and execute associated purchase transactions for the sale of such data. In certain embodiments, the seller marketplace application client module 222 may represent a client-side portion of a marketplace application hosted by the server system 108.

The illustrative seller device 104 depicted in FIG. 2 is provided by way of example only. Numerous other operating environments, system architectures, and device configurations are possible. Accordingly, embodiments of the present disclosure should not be construed as being limited to any particular operating environment, system architecture, or device configuration.

FIG. 3 illustrates a schematic block diagram of an illustrative configuration of the server system 108. The server system 108 may include any number of processor-driven devices 300, including, but not limited to, a server computer, a personal computer, one or more networked computing devices, an application-specific circuit, a minicomputer, a microcontroller, and/or any other processor-based device and/or combination of devices.

The processor-driven device(s) 300 (generically referred to herein as server computer(s) 300) may include one or more processors (processor(s)) 302 configured to access and execute computer-executable instructions stored in at least one memory 304 (generically referred to herein as memory 304). The processor(s) 302 may be implemented as appropriate in hardware, software, firmware, or combinations thereof. Software or firmware implementations of the processor(s) 302 may include computer-executable or machine-executable instructions written in any suitable programming language to perform the various functions described herein. The processor(s) 302 may include, but are not limited to, a central processing unit (CPU), a digital signal processor (DSP), a reduced instruction set computer (RISC) processor, a complex instruction set computer (CISC) processor, a microprocessor, a microcontroller, a field programmable gate array (FPGA), a System-on-a-Chip (SOC), or any combination thereof. The server system 108 may also include a chipset (not shown) for controlling communications between the processor(s) 302 and one or more other components of the server system 108. In certain embodiments, the processor(s) 302 may be based on an Intel® Architecture system, and the processor(s) 302 and chipset may be from a family of Intel® processors and chipsets, such as the Intel® Atom® processor family. The processor(s) 302 may also include one or more application-specific integrated circuits (ASICs) or application-specific standard products (ASSPs) for handling specific data processing functions, tasks, and execution of machine-readable code.

The memory 304 may include, but is not limited to, random access memory (RAM), flash RAM, magnetic media storage, optical media storage, and so forth. The memory 304 may include volatile memory configured to store information when supplied with power and/or non-volatile memory configured to store information even when not supplied with power. As will be described in more detail later in this disclosure, the memory 304 may store various program modules, application programs, and so forth that may include computer-executable instructions that upon execution by the processor(s) 302 may cause various operations to be performed. The memory 304 may further store a variety of data manipulated and/or generated during execution of computer-executable instructions by the processor(s) 202.

The server computer(s) 300 may further include one or more I/O interfaces 306 that may facilitate interaction between a user and the server system 108 using one or more I/O devices. The I/O device(s) may include, but are not limited to, a remote control, a display, a keypad, a mouse, a pointing device, a control panel, a touch screen display, a microphone, a speaker, and so forth. More specifically, the I/O interface(s) 306 may include hardware, firmware, and/or software for receiving input from a user and providing output to a user via one or more I/O devices. The I/O interfaces 306 may also be configured to facilitate receipt of input provided to peripheral devices or external sensor devices such as a global positioning system (GPS) receiver, a vehicle computing system (VCS), or the like.

The server computer(s) 300 may further include one or more network interfaces 308 that may facilitate communication between the server system 108 and one or more other systems or system components via the network(s) 106 using any suitable communications standard including any of those previously described.

Turning again to the memory 304, an operating system (O/S) 310 may be loaded therein that may be configured to manage hardware, software and/or firmware resources and provide various services to applications executing on the server computer(s) 300. The memory 304 may further include one or more datastores 312 that may store route guidance presentations 114 generated by the server system 108 as well as a variety of types of data used to generate the route guidance presentations 114 and/or otherwise associated with the presentations 114 such as, for example, the route data 116, the interactive data 118, the contextual data 120, and the trigger data 122 (not shown). The datastore(s) 312 may store information in accordance with any suitable data structure including, but not limited to, lists, arrays, databases, flat files, and so forth. In some implementations, the datastore(s) 312 may be provided externally from but accessible by the server computer(s) 300. In certain implementations, the datastore(s) 312 may be accessible via a network (e.g., one or more of the network(s) 106) using the network interface(s) 308. Although not depicted in FIG. 3, the datastore(s) 312 may include a variety of other types of data including, but not limited to, sensor data, account data, ratings data, verification data, environmental data, vehicle device data, traffic data, and so forth. For example, the datastore(s) 312 may include information associated with one or more VCSs, historical information associated with vehicle routes, customer information, customer identification information, and so forth. In certain embodiments, the datastore(s) 312 may be populated with data received from third party data sources.

The memory 304 may further include various program modules such as a contextual data generation module 314, a route guidance presentation module 316, a user account and billing module 318, and a marketplace application 320. The marketplace application 320 may include a route query module 320A and a buyer marketplace module 320B. Functionality that may be supported by each of these modules will be described in greater detail hereinafter.

As previously described, route guidance presentation(s) 114 may be generated based at least in part on route data 116 and, optionally, associated interactive data 118. The route guidance presentation generation module 314 may include computer-executable instructions for receiving the route data 116 and, optionally, associated interactive data 118, identifying one or more triggering conditions for triggering presentation of respective portions of the interactive data 118, generating trigger data 122 based at least in part on the identified triggering condition(s), and generating one or more route guidance presentations 114 based at least in part on the route data 116 and the optional interactive data 118 and trigger data 122.

The contextual data generation module 314 may include computer-executable instructions for analyzing the route data 116 and, optionally, the interactive data 118 and/or the trigger data 122 and generating the contextual data 120 to associate with the route guidance presentation(s) 114. The contextual data 120 may include metadata or various other data tags that identify aspects of the route guidance presentations 114.

The user account and billing module 318 may include computer-executable instructions for storing and managing user account profiles and associations between route guidance presentations and various users such as buyers of the route guidance presentations and/or sellers of the route data 116 based on which the route guidance presentations are generated. The user account and billing module 318 may further include computer-executable instructions for storing and managing user account information, payment information, and so forth. For example, in the case of a seller, the user account and billing module 318 may include computer-executable instructions for associating one or more route guidance presentations 114 with a seller and an associated seller device from which corresponding route data 116 was received. The user account and billing module 318 may further store information relating to one or more incentives provided to a seller for receipt of route data 116 or sale of associated route guidance presentations. In the case of a buyer, the user account and billing module 318 may store information identifying route guidance presentation(s) 114 purchased by the buyer as well as associated payment information.

The marketplace application 320 may include computer-executable instructions that when executed by the processor(s) 302 may provide sellers and buyers with a marketplace for selling, buying and exchanging route guidance presentations 114. In various embodiments, the marketplace application 320 may be a server-side portion of a distributed application configured to interface with and receive and respond to requests from the buyer marketplace application client module 128 and the seller marketplace application client module 222. In various embodiments, the server system 108 may host the marketplace application 320 while in other embodiments, the marketplace application 320 may facilitate access to a third-party marketplace platform for selling, buying and exchanging the route guidance presentations 114.

More specifically, in various illustrative embodiments, the marketplace platform may be a third-party marketplace, website, or content aggregator. The marketplace application 320 may interface with a third-party website, marketplace, or content aggregator to allow both sellers and buyers to interact with the server system 108 through a content aggregator website to purchase route guidance presentations 114 and to access and manage various user accounts. In certain embodiments, the third-party website may present offers for various products and services including offers for route guidance presentations 114. Further, in certain embodiments, the marketplace platform may host an electronic catalog that may include offers for route guidance presentations 114.

In one or more illustrative embodiments, a seller may access the marketplace application 320 using the seller marketplace application client module 222 provided on a seller device 104. Similarly, a buyer may access the marketplace application 320 using the buyer marketplace application client module 128 provided on a buyer device 112. In various embodiments, the marketplace application 320 may be a browser-based application, a dedicated smartphone or tablet application, or any other suitable application executable on any suitable platform. The marketplace application 320 may receive hypertext markup language (HTML) requests from the buyer marketplace application client module 128 and/or the seller marketplace application client module 222 and provide responses thereto. The marketplace application 320 may be configured to provide a user interface (e.g., a graphical user interface (GUI)) capable of being rendered on a buyer device 112 and/or a seller device 104 using the buyer marketplace application client module 128 and the seller marketplace application client module 222, respectively. Sellers may interact with the user interface to manage the transmission of route data 116 to the server system 108 and to receive compensation in exchange for the sale of route guidance presentations generated based on the received route data 116. Buyers may interact with the user interface to search or browse for route guidance presentations 114, create user profiles, purchase route guidance presentation(s), transmit payment information, provide rating information for route guidance presentations 114, and so forth.

In various embodiments, a user such as a buyer or a seller may be required to provide authentication credentials prior to being provided with access to the user interface associated with the marketplace application 320. In certain embodiments, rather than requiring repeated entry of authentication credentials, the server system 108 may utilize cookies or some other state-verifying technique to determine that a user is still logged in or was last logged in from the same computing device. Alternatively, or additionally, a user may maintain a session over multiple logins across multiple seller devices 104 or buyer devices 112 and/or over a period of time that may be longer than a typical Web browser session.

When prompted, a user such as a buyer or a seller may create an account with the server system 108 by providing, as input, certain identifying information such as a unique identifier (e.g., a name, a mobile telephone number, an email or messaging address, a social media application account name, etc.) and a password. In various embodiments, the user may indicate a payment method such as a bank account, a credit card account, a stored value account, or the like. In certain embodiments, a stored value account hosted by the server system 108 may be provided to the user, which the user may be permitted to load with value for use in purchasing route guidance presentations 114 or completing other transactions.

The marketplace application 320 may further include various sub-modules such as a route query module 320A and a buyer marketplace module 320B. The route query module 320A may include computer-executable instructions for receiving a query for route guidance presentations 114 from a buyer device 112 on behalf of a prospective buyer and identifying and transmitting to the buyer device 112, for presentation to the prospective buyer, route guidance presentations 114 satisfying parameters of the query. The query received from the buyer device 112 on behalf of the prospective buyer may specify various search parameters such as one or more locations and one or more preferences associated with the prospective buyer. In various embodiments, the one or more locations may include a current location of the buyer's device. In various other embodiments, a plurality of locations may be specified in the query such as, for example, an origin location and a destination location. In such embodiments, candidate route guidance presentations identified based on the query may be associated with various routes between the specified origin location and destination location. The one or more preferences specified in the query may include a preferred date, time, speed, cost, mode of transportation, or the like or a preferred seller, preferred ratings such as a minimum user rating that route guidance presentations returned by the query must satisfy, and so forth. The candidate route guidance presentations identified based on receipt of the query may be prioritized prior to presentation to the prospective buyer based on parameters specified by the prospective buyer such as, for example, purchase price, total travel time, type of route, or the like associated with the candidate route guidance presentations.

The route query module 320A may be configured to utilize various data stored in the datastore(s) 312 to identify candidate route guidance presentations. For example, the contextual data 120 may be utilized to identify candidate route guidance presentations based on the received query. The contextual data 120 may include various contextual tags that may assist in identifying candidate route guidance presentations such as, for example, contextual tags that identify position coordinates or other identifiers associated with roads, landmarks, or other elements that form part of the routes associated with the candidate route guidance presentations.

In certain embodiments, the route query module 320A may be configured to automatically retrieve candidate route guidance presentations based on various predefined preferences associated with the buyer device 112 from which the query is received and/or a prospective buyer associated with the buyer device 112. For example, the route query module 320A may be configured to automatically identify a preferred mode of transportation based on the buyer device 112 from which the query is received. Parameters automatically identified by the route query module 320A may form at least part of the search or query parameters based on which candidate route guidance presentations 114 are identified. In other embodiments, candidate route guidance presentations may be identified without first receiving a query from a buyer device. For example, the route query module 320A may be configured to automatically identify and transmit candidate route guidance presentations to a buyer device 112 based on various predetermined parameters such as various preferences associated with a buyer known to be associated with a particular buyer device.

As previously noted, the route query module 320A may include computer-executable instructions for determining a correspondence between search parameters and contextual data 120 associated with route guidance presentations and for identifying candidate route guidance presentations 114 based on the determined correspondence. Identified candidate route guidance presentations may be transmitted to a buyer device 112 and an indication thereof may be rendered for presentation to a prospective buyer via a display associated with the buyer device 112. The indication of the candidate route guidance presentations 114 may further include a respective rating and purchase price associated with each candidate route guidance presentation. User-selectable mechanisms may be provided for enabling a prospective buyer to purchase desired ones of the candidate route guidance presentations.

The buyer marketplace module 320B may include computer-executable instructions for receiving and processing requests to purchase selected route guidance presentations. For example, the buyer marketplace module 320B may receive a purchase request from a buyer device 112 on behalf of a buyer. More specifically, in various embodiments, the buyer marketplace module 320B may support a user interface via which the buyer may supply purchasing information and indicate a selection of desired route guidance presentations for purchase. The purchase request may be received via one or more of the network(s) 106. For example, the purchase request may be received via a user interface associated with the marketplace application 320.

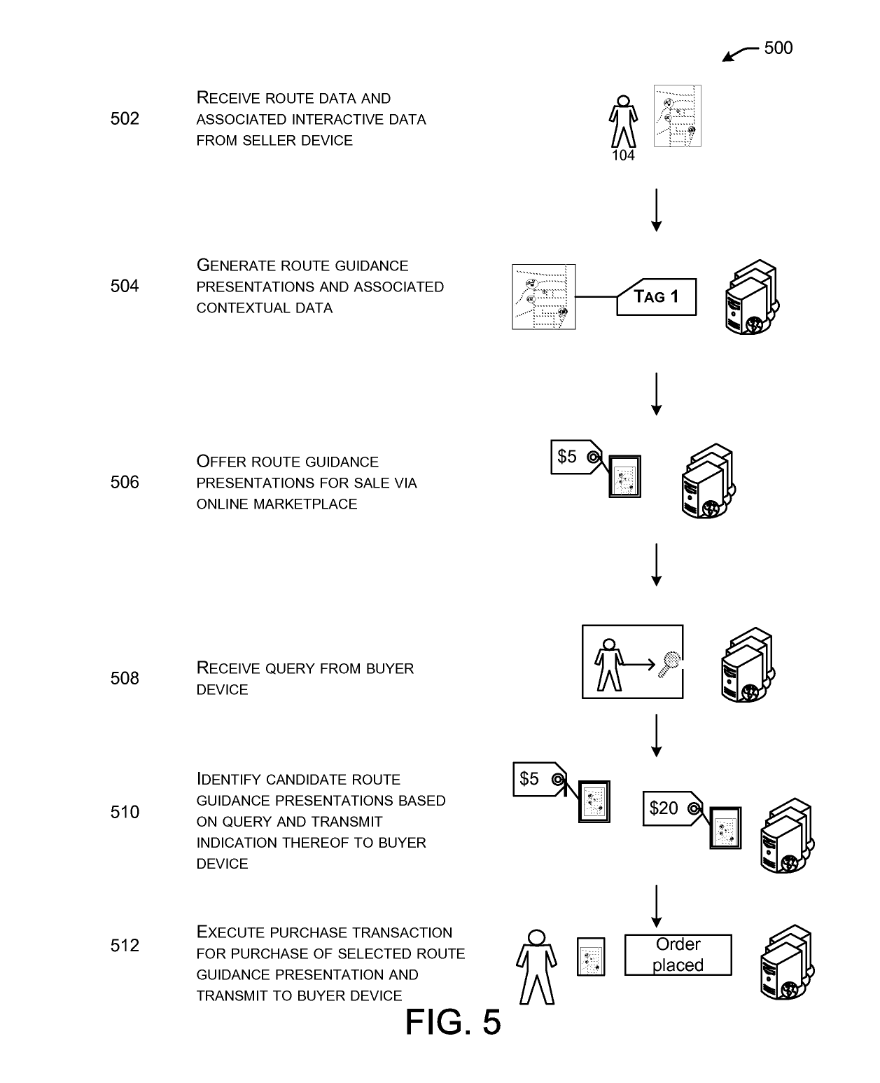

Upon receipt of a purchase request, the buyer marketplace module 320B may facilitate execution of a purchase transaction associated with the purchase request. The purchase transaction may be completed in real-time or near real-time or on a batch basis. For example, the buyer marketplace module 320B may direct the user account and billing module 318 to execute a real-time transaction associated with the received purchase request. Upon successful execution of the purchase transaction, the marketplace module 320, or more specifically, the buyer marketplace module 320B and/or one or more other applications associated with and/or in communication with the server system 108 may transmit purchased route guidance presentation(s) to the buyer device 112 associated with the buyer. In certain embodiments, the buyer marketplace module 320B and the server system 108 may provide a cross-platform, real-time purchasing system for executing purchase transactions associated with requests to purchase route guidance presentations received from buyer devices 112. Illustrative operations that may be performed by the marketplace application 320, or more specifically, the route query module 320A and/or the buyer marketplace module 320B will be described in greater detail below through reference to FIG. 5.

The illustrative server system 108 depicted in FIG. 3 is provided by way of example only. Numerous other operating environments, system architectures, and device configurations are possible. Accordingly, embodiments of the present disclosure should not be construed as being limited to any particular operating environment, system architecture, or device configuration.

FIG. 4 is a schematic of illustrative types of interactive data 118, contextual data 120, and trigger data 122 in accordance with one or more embodiments of the disclosure. It should be appreciated that while various illustrative types of interactive data 118, contextual data 120, and trigger data 122 are depicted, this disclosure is not limited to the types of data depicted and any suitable types of data may be provided.

Illustrative types of interactive data 118 may include caption data 118(A), video data 118(B), audio data 118(C), image data 118(D), and points of interest data 118(E). The caption data 116(A) may include text such as descriptive language corresponding to various points of interest or features associated with various routes. The video data 116(B) may include a plurality of image frames, such as a file or a portion thereof conforming to the MPEG-4 standard promulgated by the Motion Picture Experts Group (MPEG) or any other suitable file format or standard. The audio data 118(C) may include a file or a portion thereof conforming to the MPEG-2 Audio Layer III (MP3) standard or any other suitable file format or standard and may include data encoded with closed captions, open captions, subtitles, and so forth. The image data 118(D) may include data encoded in any suitable image format. The points of interest data 118(E) may include data relating to a particular location, an event associated with a particular location, a presentation of an object associated with a particular location, a particular activity associated with a particular location, and so forth. In certain embodiments, the points of interest data 118(E) may include one or more data elements, wherein each of the one or more data elements is associated with a respective location point along a particular route.

The contextual data 120 may include map data 120(A), time data 120(B), ratings data 120(C), travel mode data 120(D), and price data 120(E). The map data 120(A) may include, but is not limited to, data relating to street layouts, topographical data indicative of terrain, position coordinates such as latitude and longitude associated with various locations, polygons associated with the position coordinates, and so forth. The map data 120(A) may also include data representative of logical or spatial relationships such as the relative location of stations or stops along a mass transportation network.

The time data 120(B) may include data indicative of an average commute time or total commute time between origin points and destination points for a variety of routes. The ratings data 120(C) may indicate user ratings associated with various route guidance presentations, ratings provided by various third party ratings agencies, and so forth. The travel mode data 120(D) may indicate a respective preferred mode of travel associated with each route guidance presentation. For example, the route associated with each route guidance presentation may be identified as a walking route, a bicycling route, an automobile route, a public transit route, and so forth. In certain embodiments, multiple modes of travel may be associated with each route guidance presentation.

Referring now to the trigger data 122, as previously described, upon receipt of the route data 116 and the interactive data 118, the server system 108 may be configured to identify triggering conditions for triggering the presentation of associated portions of the interactive data 118. The server system 108 may then generate trigger data 122 based at least in part on the identified triggering conditions. Each triggering condition may be associated with a particular trigger location 122(A) or event along a route identified by the route data 116. Each triggering condition may be satisfied when an associated location is reached during traversal of the route or an associated event occurs. The trigger data 122 may include computer-executable instructions that specify an action 122(B) that is triggered when an associated triggering condition is met (e.g., an associated trigger location 122(A) is reached during traversal of a route). The action 122(B) that is triggered may include presentation of a particular portion of the interactive data 118 to a user. In certain embodiments, the trigger location 122(A) may be a type of location such as a “gas station” rather than a particular location itself. In certain embodiments, the trigger data 122 may be embedded within associated interactive data 118 such as the video data 116(B), the audio data 116(C), the image data 116(D), or the like. While a trigger location 122(A) is illustratively depicted in FIG. 4, it should be appreciated that triggering conditions may be associated with other parameters such as time, mode of transportation, previous location, and so forth.

### Illustrative Processes

FIG. 5 is a process flow diagram of an illustrative method 500 for generating and distributing route guidance presentations in accordance with one or more embodiments of the disclosure. Aspects of the illustrative method 500 may be implemented, at least in part, by one or more of the seller devices 104, one or more of the buyer devices 112, and/or the server system 108.

At operation 502, the server system 108 may receive route data 116 and, optionally, associated interactive data 118 from a seller device 104. The route data 116 may identify a route and associated parameters including any of those previously mentioned such as position coordinates of locations along the route such as an origin location and a destination location, a travel mode associated with the route, and so forth.

At operation 504, the server system 108 may generate a route guidance presentation based at least in part on the route data 116 and, optionally, the associated interactive data 118. The server system 108 may additionally generate contextual data 120 associated with the route guidance presentation that facilitates identification of the route guidance presentation in response to a query received from a prospective purchaser of the presentation. The route guidance presentation may be stored in association with the contextual data.

At operation 506, the route guidance presentation may be offered for sale via an online marketplace. A purchase price, terms and conditions of use, and so forth may be associated with the route guidance presentation. In certain embodiments, a special discounted price may be associated with the route guidance presentation.

At operation 508, the server system 108 may receive a query from a buyer device 112 on behalf of a prospective buyer. The query may be for a specific route guidance presentation or a more general query for candidate route guidance presentations satisfying various search parameters. The query may include an indication of one or more locations and one or more user preferences. In certain embodiments, the one or more locations may include a current location associated with the buyer device 112 from which the query was received. Candidate route guidance presentations associated with routes having an origin location corresponding to a location identified in the query may be identified. In other embodiments, candidate route guidance presentations associated with routes that include a location identified in the query at any point along the routes or are otherwise associated with the location may be identified. In still other embodiments, the query may include an indication of multiple locations such as an origin location and a destination location. For example, a user associated with the buyer device 112 may provide input indicative of an origin point and a destination point. In other embodiments, the user may simply indicate the destination point and the current location of the buyer device 112 may be taken as the origin point. The current location of the buyer device 112 may identified based on data received from a location sensor associated with the buyer device 112. Various other user preferences may be specified in the query such as, for example, preferred landmarks, preferred modes of transportation, preferred themes associated with the routes, and so forth. In other embodiments, the user preferences may be gleaned from a predefined association with the buyer device 112 or a stored profile associated with a user. It should be appreciated that the above examples are merely illustrative and that numerous other parameters may be specified in the query or gleaned from available information.

At operation 510, the server system 108 may identify candidate route guidance presentations based on the received query and transmit an indication thereof to the buyer device 112. The contextual data 120 may be utilized to determine route guidance presentations that are appropriate candidates based on the search parameters associated with the query. The indication of the candidate route guidance presentations may further include a ranking or prioritization of the presentations based on user preferences as well as a respective purchase price associated with each route guidance presentation.

At operation 512, an indication of a selection of a route guidance presentation for purchase may be received by the server system 108 and a purchase transaction for purchase of the selected presentation may be executed. In certain embodiments, a buyer may utilize the buyer device 112 to purchase desired route guidance presentations. More specifically, the buyer may interact with a user interface associated with the marketplace application 320 to initiate the purchase and provide required purchase information. In certain embodiments, the buyer may establish an account with the marketplace application 320 to facilitate purchase of route guidance presentations. The buyer may supply payment information such as a desired payment method which may be stored to facilitate subsequent purchases. In certain embodiments, the buyer may fund a stored value account associated with the buyer's profile. In certain embodiments, upon purchase of a route guidance presentation, the server system 108 may compensate a seller who provided route data 116 associated with the purchased route guidance presentation with an applied incentive. The applied incentive may include various monetary or non-monetary compensation including, but not limited to, (i) a fixed monetary discount, (ii) a percentage discount, or (iii) related items and offers.

It should be appreciated that various modifications to the illustrative method 500 are within the scope of this disclosure. For example, one or more operations of the method 500 may be eliminated or executed out of order in certain embodiments. Additionally, other operations not depicted may be performed as part of the method 500 in accordance with other embodiments.

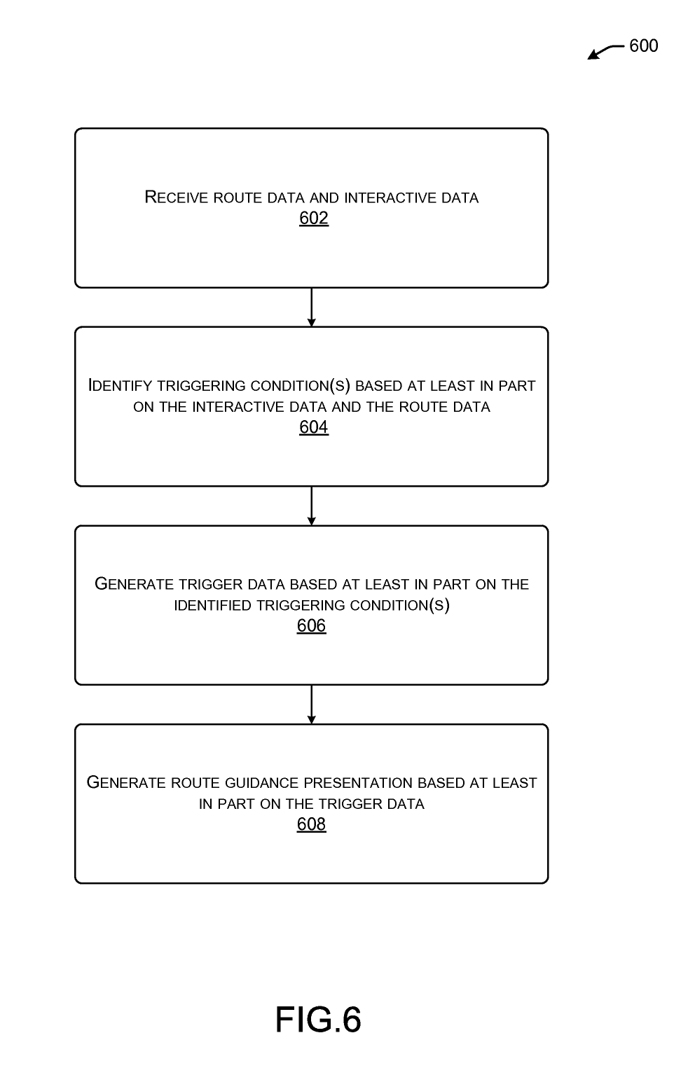

FIG. 6 is a process flow diagram of an illustrative method 600 for generating trigger data in accordance with one or more embodiments of the disclosure. Aspects of the illustrative method 600 may be implemented, at least in part, by the seller device 104 and/or the server system 108.

At operation 602, the server system 108 may receive route data 116 and associated interactive data 118 from a seller device 104. At operation 604, one or more triggering conditions for triggering the presentation of associated portions of the interactive data 118 may be identified based at least in part on the route data 116 and the interactive data 118. At operation 606, the server system 108 may then generate trigger data 122 based at least in part on the identified triggering conditions. At operation 608, the route guidance presentation that is generated based on the route data 116 and the interactive data 118 may be further generated based at least in part on the trigger data 122. In various embodiments, each identified triggering condition may be associated with a particular trigger location, event, or other parameter associated with a route identified by the route data 116. Each triggering condition may be satisfied when the associated trigger occurs (e.g., the trigger location is reached during traversal of the route). The trigger data 122 may include computer-executable instructions that specify an action that is triggered when an associated triggering condition is met. The action that is triggered may include presentation of a particular portion of the interactive data 118 to a user.

It should be appreciated that various modifications to the illustrative method 600 are within the scope of this disclosure. For example, one or more operations of the method 600 may be eliminated or executed out of order in certain embodiments. Additionally, other operations not depicted may be performed as part of the method 600 in accordance with other embodiments.

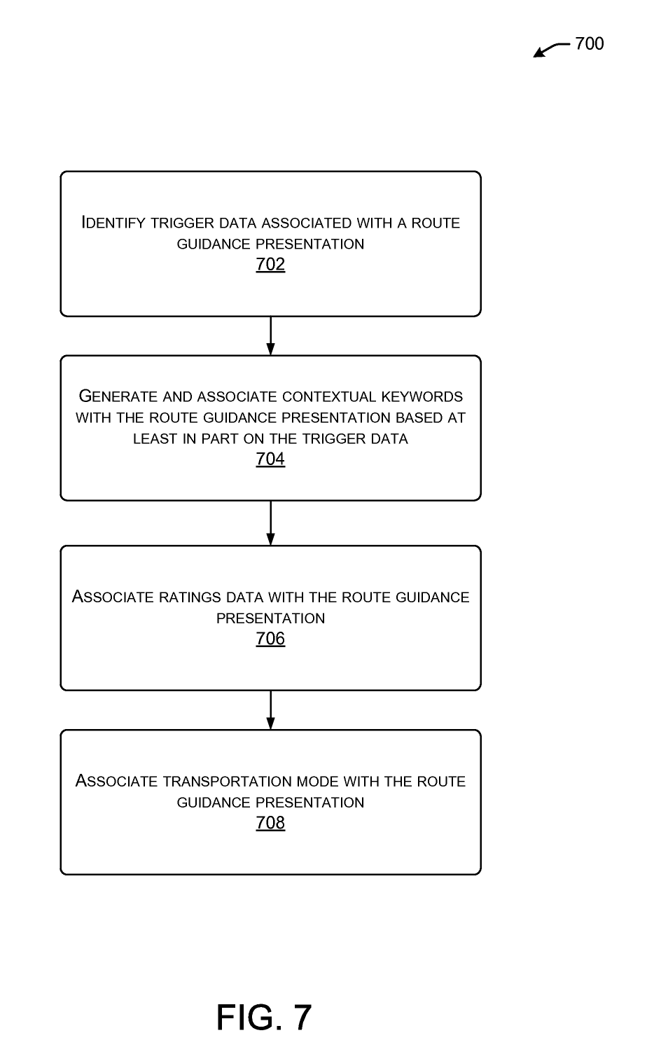

FIG. 7 is a process flow diagram of an illustrative method 700 for generating various types of contextual data in accordance with one or more embodiments of the disclosure. Aspects of the illustrative method 700 may be implemented, at least in part, by the server system 108.

At operation 702, the server system 108 may identify trigger data associated with a route guidance presentation. At operation 704, the server system 108 may generate and associate contextual keywords with the route guidance presentation based at least in part on the trigger data. The contextual keywords may be identified from interactive data that is presented to a user when associated triggering conditions are met. For example, if a triggering condition is met when a user reaches the “Taj Mahal” during traversal of a route and associated interactive data that includes an image of the “Taj Mahal” is presented to the user, the server system 108 may identify contextual keywords to associate with the route guidance presentation based at least in part on the image. Whether triggering conditions associated with particular locations are met may be determined based on a correspondence between location data such as latitude, longitude, street name, and map data included in the route data 116 and position data gathered by, for example, a buyer device 112. In certain embodiments, image recognition, OCR, or any other suitable recognition methodology may be used to determine whether a triggering condition is met.

At operation 706, ratings data indicative of ratings of the route guidance presentation may be identified and associated with the presentation. The ratings may be supplied by users such as buyers of the route guidance presentations and/or sellers of the route data based on which the route guidance presentations are generated. In certain embodiments, the ratings data may be supplied by third party ratings agencies. At operation 708, the server system 108 may identify and associated a transportation mode with the route guidance presentation.

It should be appreciated that various modifications to the illustrative method 700 are within the scope of this disclosure. For example, one or more operations of the method 700 may be eliminated or executed out of order in certain embodiments. Additionally, other operations not depicted may be performed as part of the method 700 in accordance with other embodiments.

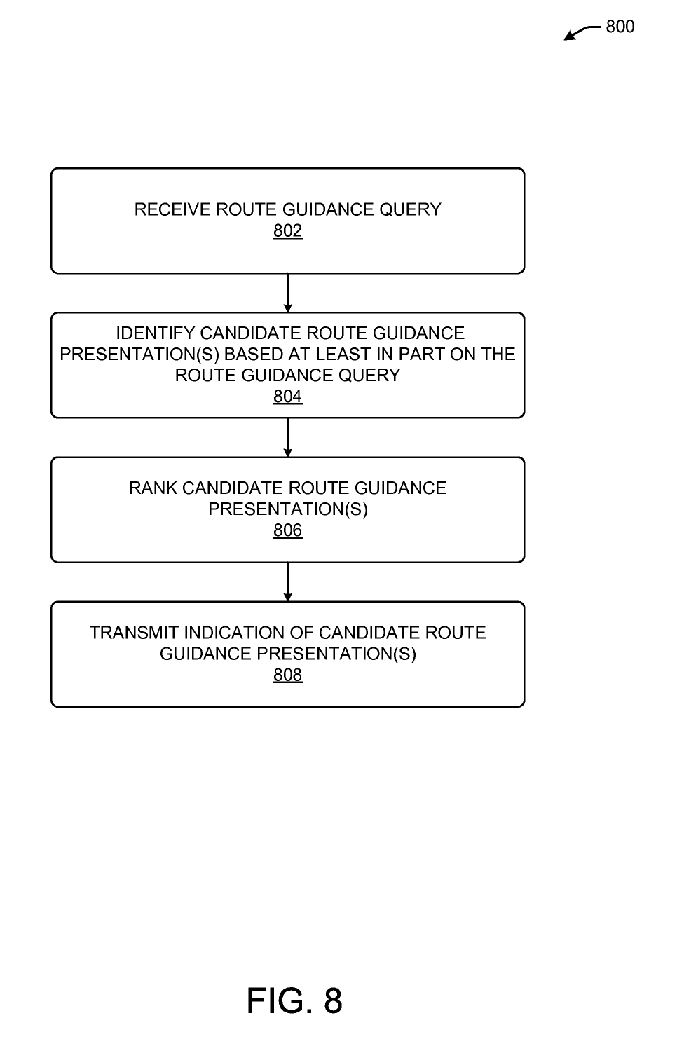

FIG. 8 is a process flow diagram of an illustrative method 800 for receiving a route guidance query and identifying candidate route guidance presentations based at least in part on the received query in accordance with embodiments of the disclosure. Aspects of the illustrative method 800 may be implemented, at least in part, by one or more of the buyer devices 112 and/or the server system 108.

At operation 802, a route guidance query may be received by the server system 108 from a buyer device 112 on behalf of a user (e.g., a prospective buyer associated with the buyer device 112). The query may specify various search parameters such as one or more locations and one or more preferences associated with the prospective buyer. The location(s) may include an origin location and a destination location associated with desired routes.

At operation 804, candidate route guidance presentations may be identified based at least in part on the received query and the search parameters associated with the query. At operation 806, the candidate route guidance presentations identified at operation 804 may be ranked. The ranking may be determined based at least in part on a correspondence between user preference(s) and contextual data associated with the presentations. At operation 808, the server system 108 may transmit an indication of the candidate route guidance presentations to the buyer device 112 from which the query was received. In certain embodiments, an indication of only the highest ranked candidate route guidance presentation may be transmitted.

It should be appreciated that various modifications to the illustrative method 800 are within the scope of this disclosure. For example, one or more operations of the method 800 may be eliminated or executed out of order in certain embodiments. Additionally, other operations not depicted may be performed as part of the method 800 in accordance with other embodiments.

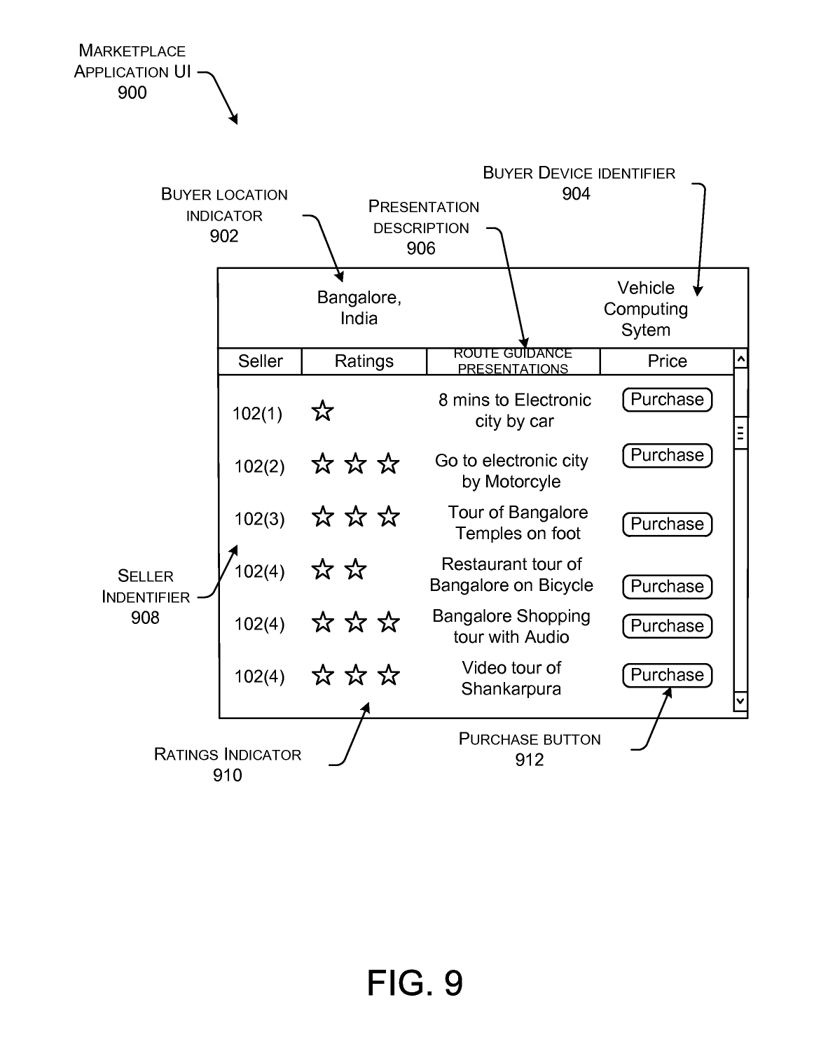

FIG. 9 schematically depicts an illustrative user interface for presenting information relating to route guidance presentations and enabling purchase thereof in accordance with one or more embodiments of the disclosure. This marketplace application user interface 900 may be rendered on a buyer device 112 by the buyer marketplace application client module 128 for example. The marketplace application user interface 900 may be associated with the marketplace application 320 which may be hosted by the server system 108 or otherwise accessible via the server system 108. While the marketplace application user interface 900 is depicted as providing graphical or visually perceived output, in certain embodiments, the presentation may be audible, haptic, or any combination thereof.

The marketplace application user interface 900 may display an indicator 902 of a buyer's location. For example, the indicator may identify a location of a buyer device 112. Further, the marketplace application user interface 900 may additionally display a buyer device identifier 904. The buyer device identifier 904 may identify a type of the buyer device 112 such as a vehicle computing system. In certain embodiments, more specific identifiers of the buyer device 112 may be displayed such as “George's IPAD.” In certain embodiments, the buyer device identifier 904 may be utilized as a criterion to further restrict a search query. For example, if the buyer device 112 is a vehicle or a computing device associated with a vehicle, the search query may be restricted to only route guidance presentations designed for use in vehicles.

The marketplace application user interface 900 may further display various descriptions 906 of route guidance presentations. The route guidance presentations may include candidate route guidance presentations identified based on a query received from the buyer device 112 on behalf of a user. The marketplace application user interface 900 further display a respective identifier 908 associated with a seller associated with each of the route guidance presentations. An indicator 910 of a respective rating associated with each route guidance presentation may also be displayed. User-selectable mechanisms 912 (e.g., a button or other selectable link) may be provided for enabling a user to purchase desired route guidance presentations. Upon purchase, the marketplace application user interface 900 may enable the buyer to rate the purchased route guidance presentation.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations have been described for generating and distributing route guidance presentations in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method, comprising:
receiving, by a server system comprising one or more computers that comprise one or more processors from a user device on behalf of a user, an indication of one or more locations and an indication of one or more preferences associated with the user;
identifying, by the server system, one or more route guidance presentations based at least in part on the one or more locations and the one or more preferences associated with the user;
transmitting, by the server system for presentation to the user via the user device, an indication of the one or more route guidance presentations;
receiving, by the server system from the user device on behalf of the user, an indication of a selected route guidance presentation of the one or more route guidance presentations; and
transmitting, by the server system for presentation to the user via the user device, the selected route guidance presentation.

2. The method of claim 1, further comprising:
receiving, by the server system from the user device on behalf of the user, a route guidance query, wherein the route guidance query comprises the indication of the one or more locations and the indication of the one or more preferences associated with the user.

3. The method of claim 2, further comprising:
transmitting, by the server system for presentation to the user via the user device, a user interface for receiving the route guidance query.

4. The method of claim 1, wherein the one or more locations comprise an origin location and a destination location.

5. The method of claim 1, wherein the user corresponds to a buyer of the selected route guidance presentation, and wherein the selected route guidance presentation is associated with a seller.

6. The method of claim 5, further comprising:
identifying, by the server system, a purchase price associated with the selected route guidance presentation;
receiving, by the server system on behalf of the buyer, transaction information for executing a financial transaction for a purchase of the selected route guidance presentation by the buyer based at least in part on the purchase price; and
transmitting, by the server system, an incentive to the seller associated with the selected route guidance presentation based at least in part on the purchase price.

7. The method of claim 6, wherein the incentive comprises at least one of:
i) remittance of at least a portion funds received on behalf of the buyer in association with the purchase of the selected route guidance presentation,
ii) a gift offer, or
iii) rewards points.

8. The method of claim 1, wherein identifying the one or more route guidance presentations comprises:
comparing, by the server system, contextual information associated with a plurality of candidate route guidance presentations with the one or more preferences associated with the buyer; and
selecting, by the server system, at least a portion of the plurality of candidate route guidance presentations as the one or more route guidance presentations based at least in part on the comparing.

9. The method of claim 1, wherein the one or more route guidance presentations are identified based at least in part on one or more user ratings associated with of the one or more route guidance presentations.

10. A system, comprising:
a server system comprising one or more computers comprising:
at least one memory storing computer-executable instructions; and
at least one processor configured to access the at least one memory and execute the computer-executable instructions to:
receive from a user device on behalf of a user an indication of one or more locations and an indication of one or more preferences associated with the user,
identify one or more route guidance presentations based at least in part on the one or more locations and the one or more preferences associated with the user;
transmit, for presentation to the user via the user device, an indication of the one or more route guidance presentations;
receive, from the user device on behalf of the user, an indication of a selected route guide presentation of the one or more route guidance presentations; and
transmit, for presentation to the user via the user device, the selected route guidance presentation.

11. The system of claim 10, wherein at least one of the one or more preferences relates to a preferred mode of transportation, and wherein the preferred mode of transportation comprises one of:
i) a vehicle;
ii) pedestrian; or
iii) public transportation;

12. The system of claim 10, wherein the one or more preferences comprise at least one of: i) an origin location or ii) a destination location.

13. The system of claim 10, wherein each of the one or more route guidance presentations is associated with:
i) a route; and
ii) one or more data elements, wherein each of the one or more data elements is associated with a respective location point along the route.

14. The system of claim 13, wherein each of the one or more data elements comprises at least one of:
i) audio data,
ii) video data, or
iii) image data.

15. The system of claim 13, wherein presentation of each of the one or more data elements to the user is triggered based at least in part on a correspondence between a current location associated with the buyer device and the respective location point associated with the data element.

16. The system of claim 10, wherein the at least one processor is further configured to execute the computer-executable instructions to:
generate a user interface; and
transmit the user interface to the user device for presentation to the user,
wherein the indication of the one or more route guidance presentations is transmitted to the user device for presentation to the user via the user interface, and
wherein the indication of the one or more locations and the indication of the one or more preferences associated with the user are received via the user-interface.

17. One or more computer-readable media, comprising:
at least one memory storing computer executable instructions that, upon execution by at least one processor, configures the at least one processor to perform operations comprising:
identifying a route and interactive data associated with the route;
identifying a triggering condition associated with the route based at least in part on the interactive data;
generating trigger data based at least in part on the triggering condition;
generating a route guidance presentation associated with the route based at least in part on the trigger data and the interactive data; and
transmitting, to one or more user devices for presentation to one or more users, an indication of the one or more route guidance presentations.

18. The one or more computer-readable media of claim 17, wherein the interactive data comprises one or more data elements, wherein the one or more data elements and the triggering condition are associated with a location point along the route.

19. The one or more computer-readable media of claim 17, wherein the one or more data elements are presented to a user of the one or more users based at least in part on satisfaction of the triggering condition, wherein the triggering condition comprises a correspondence between a location of a user device associated with the user and the location point along the route.

20. The one or more computer-readable media of claim 17, the operations further comprising:
generating contextual information associated with the route guidance presentation.

21. The one or more computer-readable media of claim 20, wherein the contextual information comprises at least one of: a keyword identifier associated with an origin location associated with the route or a keyword identifier associated with a destination location associated with the route.

22. The one or more computer-readable media of claim 20, wherein the contextual information comprises a categorization associated with the route based at least in part on an origin location and a destination location associated with the route.

23. The one or more computer-readable media of claim 20, the operations further comprising:
receiving, from at least one of the one or more users, one or more ratings associated with the route, wherein the contextual information comprises the one or more ratings.

24. The one or more computer-readable media of claim 20, the operations further comprising:
receiving, on behalf of at least one user of the one or more users, an indication of an assessment of the route,
wherein the contextual information comprises the indication of the assessment of the route.

25. The one or more computer-readable media of claim 17, wherein identifying a route comprises:
receiving, from a location determining device, a plurality of location coordinates traversed by the location determining device; and
determining the route based at least in part on the plurality of location coordinates.

26. The one or more computer-readable media of claim 17, wherein the route guidance presentation comprises a map that provides a graphical representation of the route.

27. The one or more computer-readable media of claim 26, wherein the map further provides a representation of a current location associated with a user device of the one or more user devices.

28. A method, comprising:
identifying, by a user device and based at least in part on input received from a user associated with the user device, one or more locations and one or more preferences associated with a user;
transmitting, by a user device to a server system, an indication of the one or more locations and the one or more preferences associated with the user;
receiving, by the user device from the server system and responsive to the transmitted indication, information associated with one or more route guidance presentations;
presenting, by the user device via a user interface associated with the user device, a presentation of the information associated with the one or more route guidance presentations.

29. The method of claim 28, further comprising:
identifying, by the user device and based at least in part on input received from the user, a selected route guidance presentation of the one or more route guidance presentations;
transmitting, by the user device to the server system, an indication of the selected route guidance presentation;
receiving, by the user device from the server system, the selected route guidance presentation, responsive to transmitting the indication of the selected route guidance presentation; and
presenting, by the user device via the user interface to the user, the selected route guidance presentation.

30. The method of claim 29, wherein the selected route guidance presentation comprises interactive data associated with one or more triggering conditions, further comprising:
determining, by the user device, that one triggering condition of the one or more triggering conditions is satisfied; and
presenting, by the user device via the user interface to the user, at least a portion of the interactive data associated with the one triggering condition.
